(19) United States
(12) Patent Application Publication
(10) Pub. No.: US 2011/0261808 A1
(43) Pub. Date: Oct. 27, 2011

(54) Server Apparatus and DTMF Notification Method

(76) Inventor: Norimasa Niiya, Tachikawa-shi (JP)

(21) Appl. No.: 13/047,559

(22) Filed: Mar. 14, 2011

(30) Foreign Application Priority Data
Apr. 26, 2010 (JP) 2010-101487

(51) Int. Cl. H04L 12/66

(52) U.S. Cl. 370/352

(57) ABSTRACT

According to one embodiment, a server apparatus includes a detector and a controller. The detector detects a dual tone multi frequency (DTMF) notification event sent from a communication partner server apparatus in a state that voice communication is performed between telephone terminals by way of a plurality of server apparatuses. The controller executes at least one of a change of a payload type included in a header of a received communication packet and a replacement of a payload data of the communication packet with a DTMF data, based on a detection result by the detector.

### CROSS-REFERENCE TO RELATED APPLICATIONS

This application is based upon and claims the benefit of priority from Japanese Patent Application No. 2010-101487, filed Apr. 26, 2010; the entire contents of which are incorporated herein by reference.

### FIELD

Embodiments described herein relate generally to a server apparatus, which notifies by means of a dual tone multi frequency (DTMF) sound during calling between telephone terminals, and to a DTMF notification method used for the server apparatus.

### BACKGROUND

In recent years, an IP telephone system has come into wide use. According to the IP telephone system, an image and voice are bidirectionally transmitted and received as a Real-time Transport Protocol (RTP) packet in real time by way of an Internet Protocol (IP) network. Of course, according to the IP telephone system, a communication between extensions and trunk outgoing and incoming are performed every communication server connected to an IP network. In addition, an extension communication and trunk outgoing and incoming are performed between communication servers by way of an IP network.

In the foregoing IP telephone system, auto-operator and a voice mailer are used. In a system using auto-operator, for example, if an incoming call from trunk arrives, the call is connected to auto-operator. Then, the auto-operator sends a guidance message of recommending inputting a number corresponding to the desired date and time of redelivery to the trunk call. When a caller sends a telephone number comprising a DTMF signal by a dial operation, the auto-operator detects the DTMF signal to accept the redelivery.

Moreover, in a system using a voice mailer, if user desires to hear a voice message recorded in a mailbox, the user of a telephone terminal received in a communication server makes a dial operation to send a reproduction request comprising a DTMF signal. Then, the voice mailer detects the foregoing DTMF signal to reproduce a voice message of the mailbox.

According to the foregoing IP telephone system, a DTMF signal is output to a terminal such as auto-operator and a voice mailer. In this case, a DTMF signal generated by a communication server is mixed to a received RTP packet, and then, sent to the terminal. For this reason, a digital signal processor (DSP) is required, and therefore, a simultaneous using frequency is limited due to a limitation of DSP resource. Moreover, if a DTMF event packet such as RFC 2833 (RFC 4733) is inserted into an RTP packet, a packet loss and a packet arrival timing delay occur; as a result, QOS data becomes worse. Further, if payload is different between communication servers, a packet communication by RFC 2833 (RFC 4733) is not performed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view schematically showing the configuration of an IP telephone system according to a first embodiment;

FIG. 2 is a block diagram showing a function of a call control server shown in FIG. 1;

FIG. 3 is a view showing one example of the content of a DTMF ability table shown in FIG. 2;

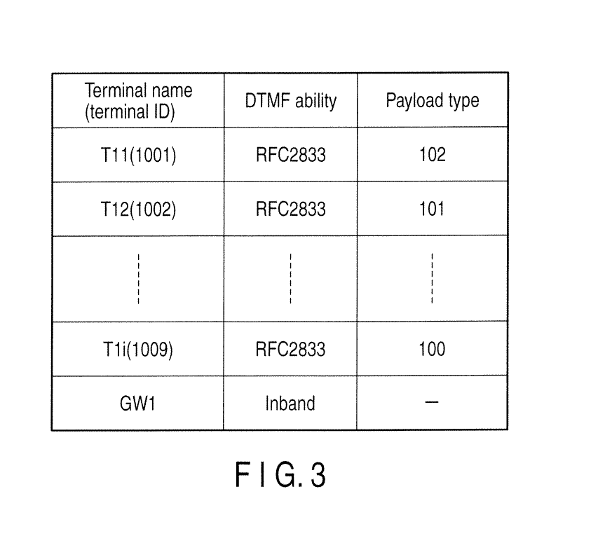

FIG. 4 is a view to explain the sequence of notifying a DTMF signal in a first embodiment;

FIG. 5 is a view showing the structure of an RTP packet handled in a first embodiment;

FIG. 6 is a view to explain the sequence of making a communication connection between IP telephone terminals by way of a plurality of call control servers in a first embodiment;

FIG. 7 is a view to explain the sequence of notifying a DTMF signal according to a second embodiment; and

FIG. 8 is a view showing the structure of an RTP packet handled in a second embodiment.

### DETAILED DESCRIPTION

Various embodiments will be described hereinafter with reference to the accompanying drawings. In general, according to one embodiment, a server apparatus being connected to a communication network for transmitting a communication packet including a header and a payload, and registering a telephone terminal, comprising: a detector configured to detect a dual tone multi frequency (DTMF) notification event sent from a communication partner server apparatus in a state that voice communication is performed between telephone terminals by way of a plurality of server apparatuses; and a controller configured to execute at least one of a change of a payload type included in a header of a received communication packet and a replacement of a payload data of the communication packet with a DTMF data, based on a detection result by the detector.

### First Embodiment

An RFC 2833 method if given as a method of sending a DTMF signal handled in a first embodiment on an IP network. The foregoing RFC 2833 method is a method of coding the DTMF signal using a codec such as G.722, G.723, G.728 and G.729, and then, inserting the coded DTMF data into a payload of an RTP packet. However, an IP telephone system includes an IP telephone terminal and a server apparatus, which do not support the foregoing RFC 2833 method. For example, encoding DTMF information is sent from an IP telephone terminal, which does not support the RFC 2833 method, to an IP telephone terminal, which supports the same method. In this case, the receiver IP telephone terminal does not recognize a DTMF because the encoding DTMF information sent to the self has not an RTP packet format.

In order to solve the foregoing problem, according to the first embodiment, a DTMF is generated in the following manner. Specifically, voice communication is performed between an IP telephone terminal connected to an RFC 2833 support server apparatus and an IP telephone terminal connected to an RFC 2833 non-support server apparatus. In the foregoing state, if a DTMF signal is sent from the non-support IP telephone terminal, encoding DTMF information received by the RFC 2833 support server apparatus is generated into an RTP packet format. Then, the generated RTP packet is sent to the destination IP telephone terminal so that the destination IP telephone terminal generates a DTMF.

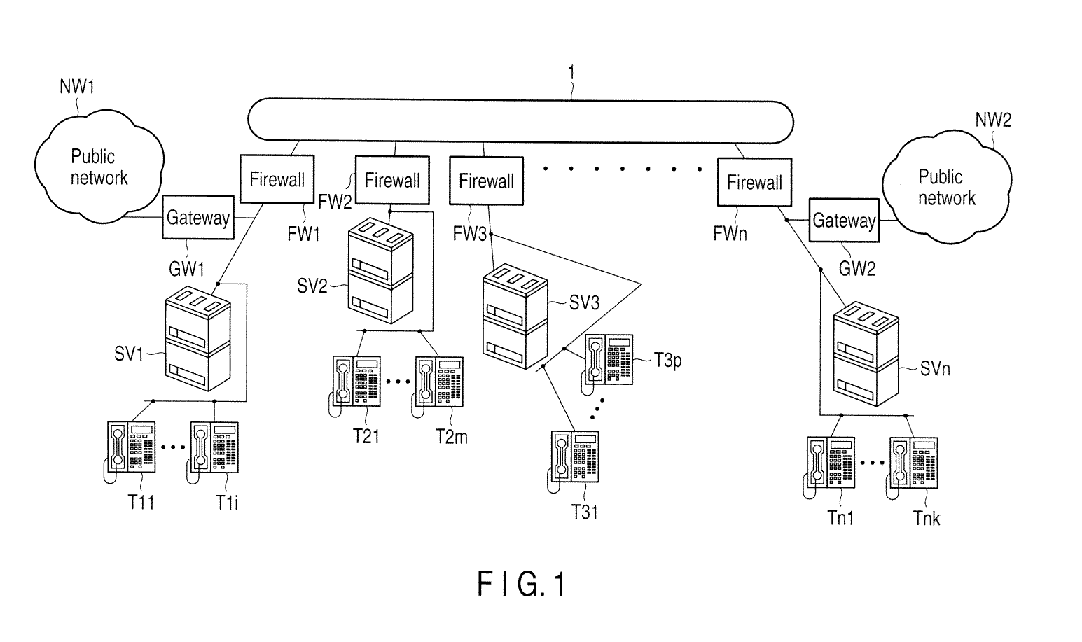

FIG. 1 is a view schematically showing the configuration of an IP telephone system according to a first embodiment.

The foregoing system has a packet communication IP network 1 as a communication network. The IP network 1 is connected with a plurality of call control servers SV1 to SVn (n=natural number). These call control servers SV1 to SVn are connected with IP telephone terminals T11 to T1i (i=natural number), T21 to T2m (m=natural number), T31 to T3p (p=natural number), and Tn1 to Tnk (k=natural number), respectively. In this case, the foregoing IP telephone terminals T11 to T1i, T21 to T2m, T31 to T1p and Tn1 to Tnk each have a call processing module and a media information processing module such as video.

Call control server SV1 is connected to the IP network 1 by way of a firewall FW1. Call control server SV2 is connected to the IP network 1 by way of a firewall FW2. Likewise, call control servers SV3 to SVn are connected to the IP network 1 by way of firewalls FW3 to FWn.

Moreover, call control server SV1 is connected with a gateway GW1. Gateway GW1 makes a connection between a public network NW1 and the IP network 1. Further, gateway GW1 has a communication protocol and signal format conversion module between the foregoing public network NW1 and IP network 1.

Call control server SVn is connected with a gateway GW2. Gateway GW2 makes a connection between a public network NW2 and the IP network 1. Further, gateway GW1 has a communication protocol and signal format conversion module between the foregoing public network NW2 and IP network 1.

Call control servers SV1 to SVn each have an exchange control module. Specifically, according to the exchange control module, a session is established according to IP-QSIG between a plurality of IP telephone terminals T11 to T1i, T21 to T2m, T31 to T3p and Tn1 to Tnk or between call control servers SV1 to SVn or between IP telephone terminals T11 to T1i, T21 to T2m, T31 to T3p, Tn1 to Tnk and public networks NW1, NW2. After the foregoing session is established, an RTP packet is transmitted and received according to a peer-to-peer connection between sender and receiver telephone terminals; in this way, voice communication is performed.

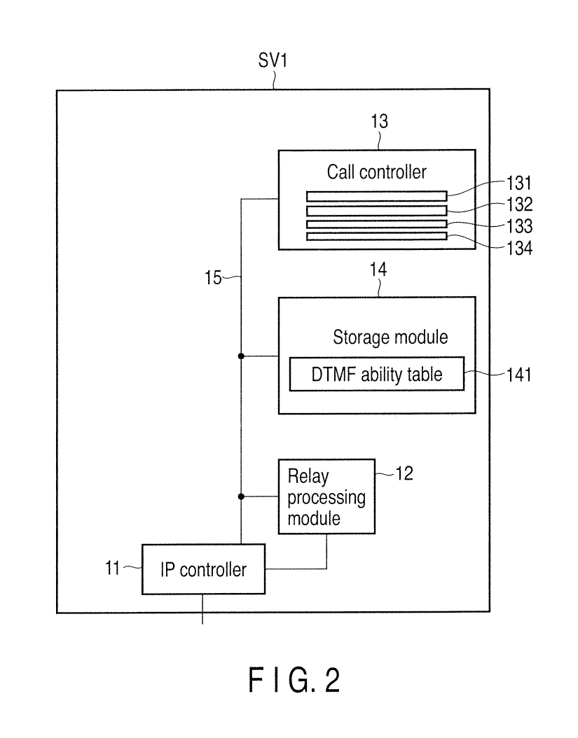

Further, the foregoing call control servers SV1 to SVn have the following module as a module according to the first embodiment. FIG. 2 is a block diagram showing the configuration of the foregoing module. Hereinafter, call control server SV1 will be given as a typical example.

Specifically, call control server SV1 includes an IP controller 11, a relay processing module 12, a call controller 13 and a storage module 14. The foregoing IP controller 11, relay processing module 12, call controller 13 and storage module 14 are mutually connected by way of a data highway 15.

The IP controller 11 is connected with an IP network 1 as the necessity arises. The IP controller 11 executes an interface processing with the connected IP network 1. Further, the IP controller 11 makes an exchange of various control information related to the foregoing interface processing with the call controller 13 by way of the data highway 15.

The relay processing module 12 processes control message and RTP packet received by the IP controller 11.

The call controller 13 is configured having a CPU, a ROM and a RAM, and controls each module of the call control server SV1 by means of a software processing.

The storage module 14 stores routing information required for the connection control of the call controller 13. The foregoing routing information is information associated with the following various data. One is telephone numbers given as identification information previously assigned to IP telephone terminals T11 to T1i and gateway GW1. Another is a Media Access Control (MAC) address given as a fixed network address. Another is an IP address given as a variable network address.

The foregoing storage module 14 is provided with a DTMF ability table 141. The DTMF ability table 141 is a table used for managing a transmission/reception ability of a DTMF signal of IP telephone terminals T11 to T1i and gateway GW1. Specifically, the table 141 shows the correspondence relationship of the following factors. One is a terminal number given as a terminal ID, which is previously assigned to IP telephone terminals T11 to T1i and gateway GW1 connected to call control server SV1. Another is a DTMF ability. Another is a payload type positioned on a header of an RTP packet including DTMF data. Information showing the DTMF ability is information showing which of RFC 2833 method or inband method. For example, the foregoing inband method is a method of inserting DTMF data coded by means of a codec such as G. 711 into a payload of an RTP packet.

The foregoing DTMF ability information showing which of RFC 2833 or inband and payload type are previously registered in the DTMF ability table 141 with respect to IP telephone terminals T11 to T1i and gateway GW1 belonging to call control server SV1.

The call controller 13 includes a DTMF notification event detector 131 (hereinafter, referred to as detector 131), a DTMF data generator 132 (hereinafter, referred to as generator 132), a payload replacement module 133 and a payload type update module 134. For example, the detector 131 detects a DTMF notification event sent from call control server SV2 in the following state. According to the foregoing state, a session is established between IP telephone terminal T11 registered in call control server SV1 and IP telephone terminal T21 registered in call control server SV2, and an RTP packet is transmitted and received.

When the detector 131 detects a DTMF notification event sent by an INFO message conforming to IP-QSIG, the generator 132 generates a DTMF data comprising a dial number included in the INFO message.

The payload replacement module 133 replaces the DTMF data generated by the foregoing generator 132 with a payload data of an RTP packet received from call control server SV2, for example.

The payload type update module 134 rewrites a payload type positioned on a header of an RTP packet into a payload type of DTMF data replaced by the foregoing payload replacement module 133. Moreover, if the foregoing detector 131 detects DTMF data included in a payload of an RTP packet, the payload type update module 134 rewrites the payload type of the RTP packet.

The operation by the foregoing configuration will be described below.

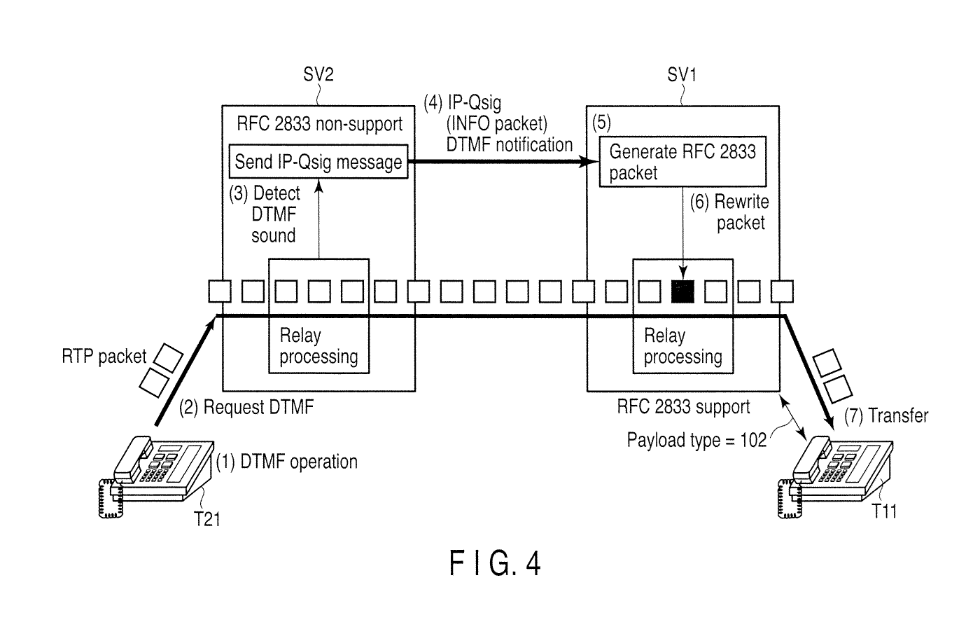

FIG. 4 is a view showing the sequence when a DTMF signal is notified from an IP telephone terminal T21 to an IP telephone terminal T11.

Now, a communication link is established between IP telephone terminals T11 and T21. In this case, for example, IP telephone terminal T11 sends an announcement message to IP telephone terminal T21 as an RTP packet according to auto-operator.

For example, a message “This is the ◯◯ company. If you have a hope of redelivery, please push the dial “1”.” is used as the content of the foregoing announcement message.

In this state, the user of IP telephone terminal T21 pushes the dial “1” (FIG. 4(1)). IP telephone terminal T21 sends a DTMF signal corresponding to the dial “1”, which is inserted into an RTP packet, to the call control server SV2 (FIG. 4(2)).

In call control server SV2, a DSP detects a DTMF signal (FIG. 4(3)). Then, server SV2 gives a notification to output a DTMF signal to IP telephone terminal T11 to call control server SV1 according to an IP-QSIG INFO message (FIG. 4(4)).

Call control server SV1 generates a DTMF data confirming RFC 2833 according to the foregoing INFO message (FIG. 4(5)).

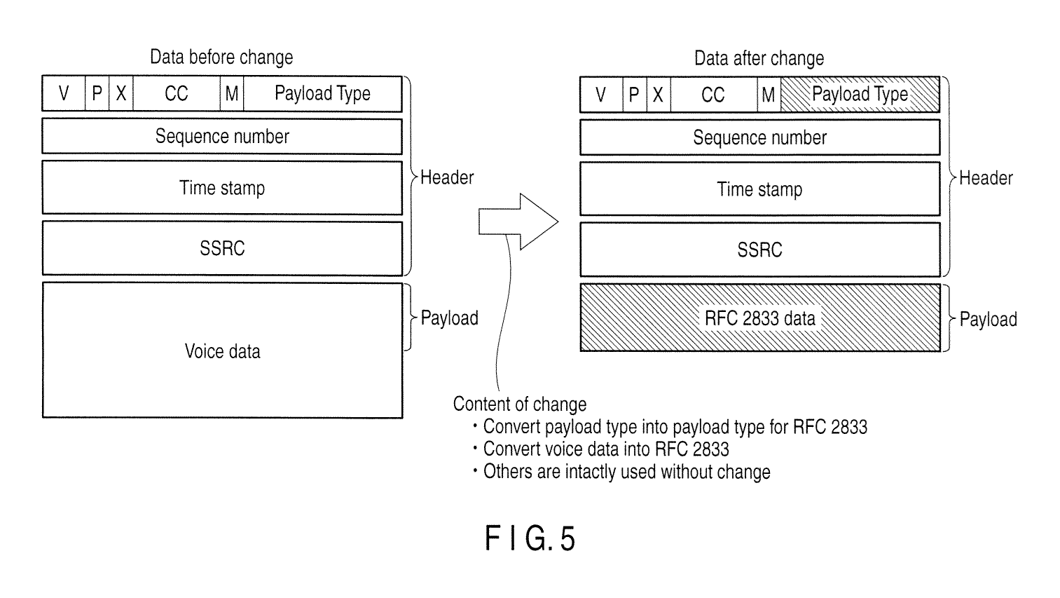

Call control server SV1 replaces a payload data with a DTMF data with respect to an RTP packet received from call control server SV2 according to a conversion rule shown in FIG. 5. Thereafter, call control server SV1 rewrites a payload type positioned on a header of an RTP packet with a payload type of DTMF data (FIG. 4(6)).

The rewritten packet is transferred to IP telephone terminal T11 (FIG. 4(7)). In this way, IP telephone terminal T11 detects an RTP packet conforming to RFC 2833, and then, recognizes that a DTMF signal is notified. In this case, IP telephone terminal T11 accepts the redelivery requested by the user of IP telephone terminal T21.

FIG. 5 shows the structure of an RTP packet. The RTP packet comprises a header and a payload. The header includes the following various information and a payload type. Specifically, one is version information showing the kind of a packet, and another is information (P) showing the existence of padding data. Another is information (X) showing the existence of extension data, and another is information (CC) showing a call classification such as a two-person call and a three-person call. Further, the header includes a sequence number showing the sending priority of an RTP packet, a time stamp showing the sending time of an RTP packet and a sender identifier (SSRC) for identifying a sender, that is, IP telephone terminal T21.

The payload includes a digital voice data coded by a codec such as G. 722, G. 723 and G. 729, for example.

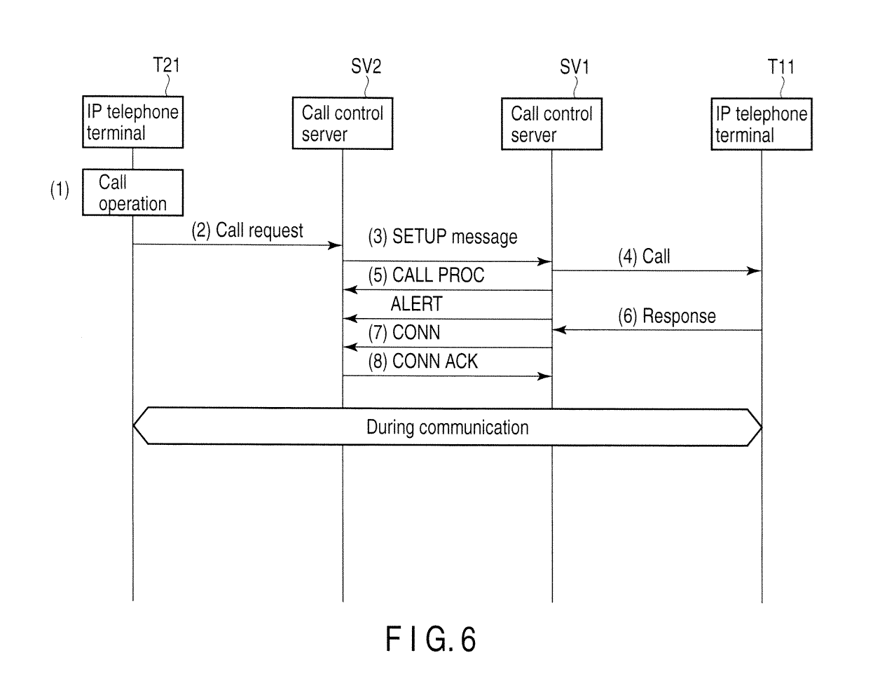

The operation of forming a communication link between the foregoing IP telephone terminals T11 and T21 will be described below. FIG. 6 is a sequence view showing the operation of forming a communication link between the foregoing IP telephone terminals T11 and T21.

As can be seen from FIG. 6, IP telephone terminal T21 registered in call control server SV2 makes a call operation with respect to the IP telephone terminal T11 registered in call control server SV1 (FIG. 6(1)). Then, IP telephone terminal T21 sends a call request to call control server SV2 (FIG. 6(2)). When receiving the foregoing call request, call control server SV2 generates a SETUP message conforming to IP-QSIG. The SETUP message includes sender and receiver identification information, a codec showing G. 711/G. 729 used for IP telephone terminal T21, and information showing RFC 2833 as a transmission/reception ability of a DTMF signal. The SETUP message is send from call control server SV2 to call control server SV1 by way of the IP network 1 (FIG. 6(3)).

When receiving the SETUP message, call control server SV1 determines whether or not RFC 2833 is supported as a sender ability from the SETUP message. Then, server SV1 refers to the DTMF ability table 141 to determine whether or not RFC 2833 is supported as an ability of the receiver, that is, IP telephone terminal T11. Simultaneously, server SV1 makes a call to IP telephone terminal T11 (FIG. 6(4)), and then, sends a message (CALL PROC, ALERT) showing that the SETUP message is correctly received to call control server SV2 (FIG. 6(5)).

When responding the call, IP telephone terminal T11 sends a response signal to call control server SV1 (FIG. 6(6)).

When receiving the response signal, from the foregoing determined result, call control server SV1 recognizes that the sender DTMF ability does not support RFC 2833 and the receiver, that is, IP telephone terminal T11 only supports RFC 2833. Specifically, IP telephone terminal T21 connected to call control server SV2 does not support RFC 2833; for this reason, terminal T21 sends information showing that RFC 2833 is not included in the SETUP message to call control server SV1. Thus, call control server SV1 recognizes that information showing RFC 2833 is not included in the received SETUP message; therefore, server SV1 recognizes call control server SV2 as an RFC 2833 non-support server.

Then, call control server SV1 establishes a communication link with the receiver, that is, IP telephone terminal T11. Further, server SV1 gives notification to call control server SV2 in a state of inserting information showing that terminal T11 is connected to server SV1 into a response message (CONN) (FIG. 6(7)).

When receiving the response message, call control server SV2 returns CONN ACK to call control server SV1 (FIG. 6(8)). Then, call control server SV2 forms a communication link with IP telephone terminal T21. In this way, a communication link via call control servers SV1 and SV2 is formed between the sender, that is, IP telephone terminal T21 and the receiver, that is, IP telephone terminal T11, and thereafter, a call is made.

According to the foregoing embodiment, a connection is made between the sender, that is, IP telephone terminal T21 and the receiver, that is, IP telephone terminal T11 by way of call control servers SV1 and SV2. In addition, there exists a peer-to-peer connection. According to the peer-to-peer connection, a connection is directly made between the sender, that is, IP telephone terminal T21 and the receiver, that is, IP telephone terminal T11 without using call control servers SV1 and SV2.

In order to make a peer-to-peer connection, the codec used for the sender that is, IP telephone terminal T21 must coincide with the codec used for the receiver, that is, IP telephone terminal T11. However, even if the foregoing both codec coincide with each other, when these terminals are connected by way of firewalls FW1 and FW2, a peer-to-peer connection is not made between IP telephone terminals T11 and T21.

As described above, according to the foregoing first embodiment, call control server SV1 detects a DTMF notification event sent by an INFO message from call control server SV2 independently from an RTP packet. In this case, server SV1 generates DTMF data inserted into a payload of an RTP packet to replace payload data of the RTP packet received from call control server SV2 with DTMF data. Further, server SV1 rewrites a payload type of an RTP packet into a payload type [102] used for IP telephone terminal T11, and thereafter, sends the rewritten payload type to IP telephone terminal T11.

Therefore, even if a call is made between IP telephone terminals T11 and T21 by way of the RFC 2833 non-support call control server SV2 and RFC 2833 support call control server SV1, IP telephone terminal T21 makes an operation of generating DTMF data. In this case, it is possible to securely send a DTMF data packet to the notified destination IP telephone terminal T11.

Moreover, according to the foregoing first embodiment, a DTMF event packet notification is given to the notified destination IP telephone terminal T11 using a payload type included in the header of an RTP packet and a payload of an RTP packet. In this way, the DTMF event packet is able to send to IP telephone terminal T11 without providing a DSP for mixing an RTP packet and DTMF data. Therefore, this serves to release the limitation of simultaneous using frequency by DSP resource. Further, the payload type of an RTP packet is changed, and payload data is replaced; therefore, a sequence number and a time stamp do not shift. As a result, packet loss and packet delay do not occur; therefore, QOS is not worsened.

### Second Embodiment

According to the first embodiment, voice communication is performed between an IP telephone terminal connected to an RFC 2833 support server apparatus and an IP telephone terminal connected to an RFC 2833 non-support server apparatus. However, the second embodiment differs from the first embodiment in the following point. Specifically, voice communication is performed between an IP telephone terminal connected to an RFC 2833 support server apparatus and an IP telephone terminal connected to an RFC 2833 support server apparatus.

For example, an IP telephone terminal receives an RTP packet conforming to RFC 2833 from a communication sender. In this case, the terminal extracts a DTMF data inserted into an RTP packet received according to a payload type of the header recognizable by the self terminal to generate DTMF. However, if the payload type of the received RTP packet is different from a payload type recognizable by the self terminal, the IP telephone terminal cannot recognize the payload type of the RTP packet. For this reason, the terminal cannot recognize DTMF.

According to this second embodiment, when receiving an RTP packet conforming to RFC 2833 from a communication sender, an RFC 2833 support server apparatus executes the following operation. Namely, the server apparatus rewrites a payload type of the received RTP packet into a payload recognizable by the destination IP telephone terminal, and thereafter, sends it to the destination.

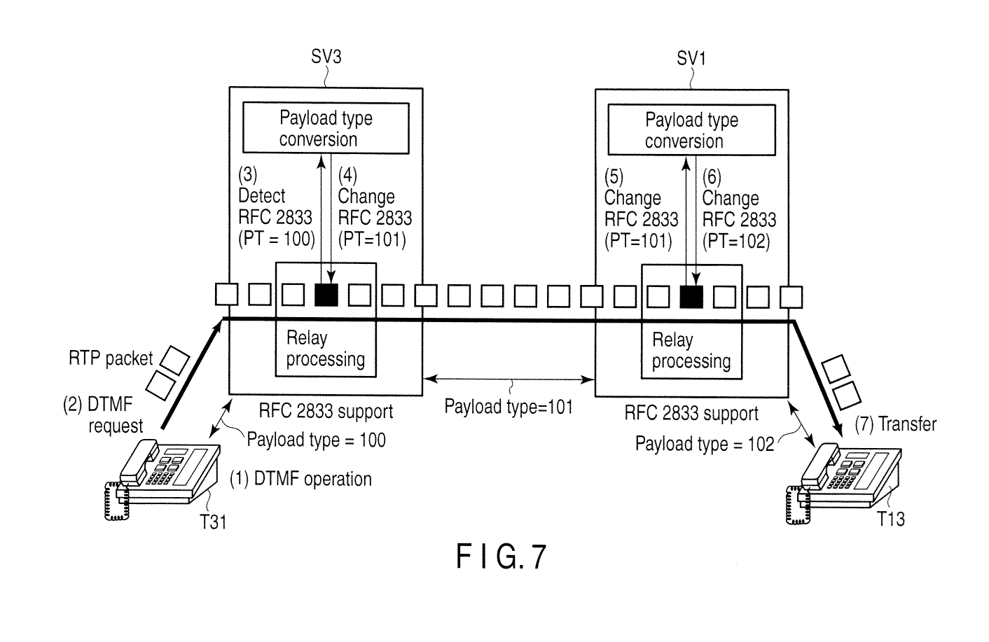

FIG. 7 shows the sequence of the case where a DTMF signal is notified from an IP telephone terminal T31 to an IP telephone terminal T13. In this embodiment, a payload type used for RFC 2833 is different as follows.

Payload type between “Call control server SV3” and “IP telephone terminal T31”=100

Payload type between “Call control server SV3” and “Call control server SV1”=101

Payload type between “Call control server SV1” and “IP telephone terminal T13”=102

If the payload type is different, it is impossible to notify a DTMF signal from IP telephone terminal T31 to IP telephone terminal T13. For this reason, the following processing is executed to realize the notification of a DTMF signal.

Now, a communication link is established between IP telephone terminals T13 and T31. For example, IP telephone terminal T13 sends an announcement message to IP telephone terminal T31 as an RTP packet using auto-operator.

For example, a message “This is the ◯◯ company. If you have a hope of purchase reservation of ΔΔ commodity, please push the dial “2”.” is used as the content of the foregoing announcement message.

In this state, the user pushes the dial “2” of IP telephone terminal T31 (FIG. 7(1)). Terminal T31 gives notification of a DTMF signal corresponding to the dial “2” to call control server SV3 using an RFC 2833 packet of “payload type=100” (FIG. 7(2)).

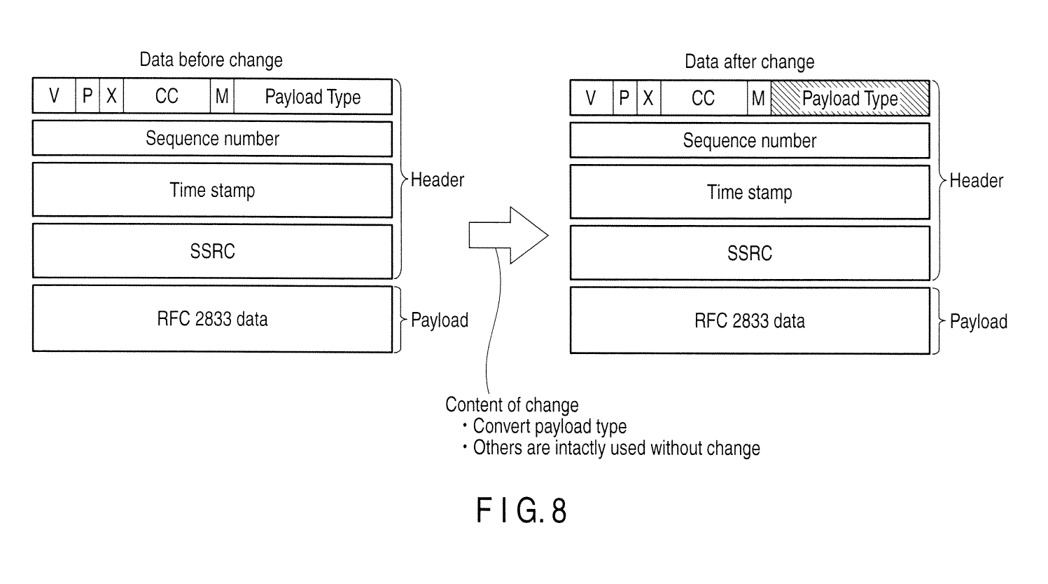

In call control server SV3, when a relay processing module 12 detects an RTP packet conforming to RFC 2833 (FIG. 7(3), the module 12 refers to a payload type of an RTP packet shown in FIG. 8. In this case, server SV3 previously stores information “101” showing a payload type of an RTP packet sent to the destination, that is, call control server SV1. Then, server SV3 determines whether or not a payload type “100” of the received RTP packet coincides with the previously stored payload type “101”.

In this case, the payload type is different. Therefore, call control server SV3 rewrites a payload type of the received RTP packet from “100” into “101”, and intactly leaves others, that is, header information such as a sequence number, a time stamp and SSRC and payload data (FIG. 7(4)).

An RTP packet having a rewritten payload type is sent to call control server SV1.

In call control server SV1, when a detector 131 detects an RTP packet conforming to RFC 2833 (FIG. 7(5)), it converts a payload type. A payload type between call control server SV1 and IP telephone terminal T13 is “102”; therefore, the payload is converted from “101” into “102” (FIG. 7(6)).

The converted RTP packet conforming to RFC 2833 is sent to IP telephone terminal T13 (FIG. 7(7)). In this way, terminal T13 detects an RFC 2833 packet having a payload type=102, and then, recognizes that a DTMF signal is notified.

As described above, according to the foregoing second embodiment, in call control server SV1, an RTP packet conforming to RFC 2833 is sent from a communication partner, that is, call control server SV3. In this case, server SV1 determines whether or not a payload type of an RTP packet is the same as a payload type rewritable by the destination, that is, IP telephone terminal T13. If the payload is different, the payload type is rewritten.

Therefore, a simple processing of changing a payload type is only executed, and thereby, a DTMF event packet is send-able to the communication destination, that is, IP telephone terminal T13.

### Other Embodiment

The present invention is not limited to the foregoing each embodiment. For example, a communication connection and notification of a DTMF signal are performed according to IP-QSIG; in this case, SIP may be used.

According to the foregoing first embodiment, the DTMF data corresponding to a dial number is inserted into a payload. For example, no-sound or predetermined voice data may be generated so that payload data of a received RTP packet is replaced with no-sound or predetermined voice data.

According to the foregoing other embodiment, in a state that a call is made between telephone terminals by way of a plurality of server apparatuses, a communication partner telephone terminal makes a request operation of generating DTMF data. In this case, a DTMF notification event arrives from the communication partner telephone terminal. Therefore, the DTMF notification event is detected, and thereby, this serves to perform at least one of a change of a payload type included in a header of a received RTP packet or a replacement of payload data of a communication packet with DTMF data is executed.

Therefore, it is possible to send a DTMF event packet to an IP telephone terminal without providing a DSP for mixing an RTP packet with DTMF data. This serves to dispense the limitation of simultaneous using frequency by DSP resource. In addition, a change of a payload type and a replacement of payload data are executed; therefore, a sequence number and a time stamp do not shift. As a result, a packet loss and a packet delay do not occur; therefore, QOS is not worsened.

Besides, the system configuration, the functional configuration of a call control server, the kind of telephone terminal and the notification method of a DTMF signal may be variously modified without departing from the scope of the invention.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server apparatus being connected to a communication network for transmitting a communication packet including a header and a payload, and registering a telephone terminal, comprising:
a detector configured to detect a dual tone multi frequency (DTMF) notification event sent from a communication partner server apparatus in a state that voice communication is performed between telephone terminals by way of a plurality of server apparatuses; and
a controller configured to execute at least one of a change of a payload type included in a header of a received communication packet and a replacement of a payload data of the communication packet with a DTMF data, based on a detection result by the detector.

2. The apparatus of claim 1, wherein the detector detects the DTMF notification event sent from the communication partner server apparatus independently from the communication packet, and
the controller comprises:
a generator configured to generate the DTMF data when the detector detects the DTMF notification event;
a replacement module configured to replace a DTMF data generated by the generator with a payload data of a communication packet during communication; and
a change module configured to change a payload type positioned on a header of the communication packet according to a payload type of the DTMF data replaced by the replacement module.

3. The apparatus of claim 1, wherein the detector detects a communication packet transmitted from the communication partner server apparatus, wherein the communication packet includes DTMF data inserted into a payload, and
the controller rewrite a payload type of a received communication packet into a payload type used for the registered telephone terminal, to send the received communication packet to the registered telephone terminal, when a payload type of the detected communication packet is different from a payload type of a communication packet sent to a registered telephone terminal.

4. The apparatus of claim 2, wherein the generator generates at least one of a no-sound data and predetermined voice data as the DTMF data, and
the replacement module replaces at least one of a no-sound data and predetermined voice data generated by the generator with a payload data of a communication packet during communication.

5. A DTMF notification method used for a server apparatus being connected to a communication network for transmitting a communication packet including a header and a payload, and registering a telephone terminal, comprising:
detecting a dual tone multi frequency (DTMF) notification event sent from a communication partner server apparatus in a state that voice communication is performed between telephone terminals by way of a plurality of server apparatuses; and
executing at least one of a change of a payload included in a header of a received communication packet and a replacement of a payload data of the communication packet with a DTMF data, based on a detection result by the detecting.

6. The method of claim 5, wherein the detecting includes detecting the DTMF notification event sent from the communication partner server apparatus independently from the communication packet, and
the executing includes:
generating the DTMF data in response to the DTMF notification event;
replacing the DTMF data with a payload data of a communication packet during communication; and
changing a payload type positioned on a header of the communication packet according to a payload type of the replaced DTMF data.

7. The method of claim 5, wherein the detecting includes detecting a communication packet transmitted from the communication partner server apparatus, wherein the communication packet includes DTMF data inserted into a payload, and
the executing includes rewriting a payload type of a received communication packet into a payload type used for the registered telephone terminal, to send the received communication packet to the registered telephone terminal, when a payload type of the detected communication packet is different from a payload type of a communication packet sent to a registered telephone terminal.

8. The method of claim 6, wherein the generating includes generating at least one of a no-sound data and predetermined voice data as the DTMF data, and
the replacing includes replacing at least one of a no-sound data and predetermined voice data generated by the generator with a payload data of a communication packet during communication.
